(19) United States
(12) Patent Application Publication
(10) Pub. No.: US 2014/0365313 A1
(43) Pub. Date: Dec. 11, 2014

(54) PROVIDING PERSONALIZED RECOMMENDATIONS RELATING TO GROUP ACTIONS

(71) Applicant: OpenTable, Inc., San Francisco, CA (US)

(72) Inventors: COREY LAYNE REESE, Portola Valley, CA (US); BRETT MATTHEW WESTERVELT, Menlo Park, CA (US); YIGE WANG, East Palo Alto, CA (US); JEREMY RYAN SCHIFF, San Francisco, CA (US)

(21) Appl. No.: 14/301,048

(22) Filed: Jun. 10, 2014

Related U.S. Application Data
(60) Provisional application No. 61/833,042, filed on Jun. 10, 2013.

(51) Int. Cl. G06Q 30/02

(52) U.S. Cl. CPC G06Q 30/0269
USPC 705/14.66

(57) ABSTRACT

A recommendation engine provides a plurality of users with a recommendation for a common group action. The recommendation engine can take into user information such as explicit or implicit preferences of the participant of the group action in recommending a group action, such as shopping together, buying together, going to an event together, engaging in an activity together, etc. By considering the group, as well as the individuals, the recommendation engine can make recommendations optimized for a goal of one or more of the individuals, or for a group goal, which might not have been a recommendation made for any one of the individuals if considered in isolation. Additionally, in certain embodiments, the recommendation engine recommends an item related to a planned group activity for a group including a plurality of individuals based on information relating to each of the plurality of individuals.

### BENEFIT CLAIM

This application claims the benefit under 35 U.S.C. §119 of provisional application 61/833,042, filed Jun. 10, 2013, the entire contents of which are hereby incorporated by reference herein for all purposes as if fully set forth herein.

### FIELD OF THE DISCLOSURE

The present disclosure relates to methods and systems for recommending group actions that involve multiple individuals and items related to group actions that are planned.

### BACKGROUND

The approaches described in this section could be pursued, but are not necessarily approaches that have been previously conceived or pursued. Therefore, unless otherwise indicated herein, the approaches described herein are not admitted to be prior art by inclusion in this section.

Despite the wide variety of recreational or other activities available for people to participate in as groups, people often fall into a routine of participating in the same activities with the same people, even despite desires to do otherwise. This may be attributable to the extra effort a person must exert to determine which activities would be of interest to which people or which people would be available at particular times.

People would benefit from a system that recommends group actions for a group to commonly participate in and/or which people should participate in the group action. Additionally, people attending or hosting activities may benefit from a system that recommends an item relating to a group activity that has already been planned.

### SUMMARY

The appended claims may serve as a summary of the invention.

### BRIEF DESCRIPTION OF THE DRAWINGS

FIG. 1 is a schematic of an embodiment of the recommendation system including a recommendation engine.

FIG. 2 is an example of an interface displaying both group action recommendations and a recommendation for an item relating to a planned group activity.

FIG. 3 is an example of an interface displaying multiple group action recommendations and requesting feedback to enable coordination between different individuals of a group.

FIG. 4 is an example of a TV console interface displaying group action recommendations determined by a recommendation engine.

FIG. 5 is an example interface using which users may provide input and request group action recommendations.

FIG. 6 illustrates an example process for determining and presenting a group action recommendation.

FIG. 7 illustrates an example process for selecting a group to recommend from among a plurality of group actions with an objective of maximizing the satisfaction of the least satisfied user.

FIG. 8 illustrates an example process for determining and presenting a recommendation for an item relating to a planned group activity.

FIG. 9 is a block diagram that illustrates a computer system upon which an embodiment of the invention may be implemented.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

### 1. General Overview

### 2. Structural and Functional Overview

### 2.1 Example Recommendation System

### 2.2 Example Recommendation Processes

### 2.3 Information Used to Select A Group Action Recommendation

### 2.4 Example Types Of Group Action Recommendations

### 2.5 Recommendation Objectives

### 2.6 Presentation Of Recommendations Relating to Group Actions

### 2.7 Recommending an Item for a Planned Group Activity

### 3. Implementation Mechanism—Hardware Overview

### 1. General Overview

Techniques for providing personalized recommendations relating to group actions are described. A recommendation engine provides a plurality of users with a recommendation for a common group action. The recommendation engine can take into account user information such as explicit or implicit preferences of the participant of the group action in recommending a group action, such as shopping together, buying together, going to an event together, engaging in an activity together, etc. By considering the group, as well as the individuals, the recommendation engine can make recommendations optimized for a goal of one or more of the individuals, or for a group goal, which might not have been a recommendation made for any one of the individuals if considered in isolation. Additionally, in certain embodiments, the recommendation engine recommends an item related to a planned group activity for a group including a plurality of individuals based on information relating to each of the plurality of individuals.

According to an embodiment, a computer determines information relating to each of a plurality of individuals. Based on the information relating to each of the plurality of individuals, a group action recommendation is determined relating to a group comprising two or more individuals of the plurality of individuals and comprising an action for the group to participate in. The group action recommendation is caused to be presented at a device associated with a particular individual of the plurality of individuals.

In some embodiments, for each group action of two or more group actions, a set of predicted satisfaction values are determined, where the set of predicted satisfaction values includes a predicted satisfaction value for each individual of the plurality of individuals indicating how satisfied the individual will be with a recommendation for the group action. For each group action of the two or more group actions, a minimum satisfaction value is selected from the set of predicted satisfaction values associated with the group action, where the minimum satisfaction value indicates how satisfied a least satisfied individual of the plurality of individuals is with the group action. A particular group action is selected for recommendation over other group actions of the two or more group actions based on a determination that a minimum satisfaction value associated with the particular group action is greater than minimum satisfaction values associated with all other group actions.

In some embodiments, predicted satisfaction values indicating a prediction of how satisfied the individual will be with a plurality of group action recommendations are determined for each individual of a plurality of individuals. A particular group action recommendation from the plurality of group action recommendations is selected, where predicted satisfaction values associated with a first set of one or more individuals of the plurality of individuals are weighted more heavily than predicted satisfaction values associated with a second set of one or more individuals of the plurality of individuals during the selecting.

In some embodiments, predicted satisfaction values are determined for each individual of a first individual and a second individual, where the predicted satisfaction values indicate a prediction of how satisfied the individual will be with a plurality of group action recommendations. Tests are performed to determine a context of a group action associated with the group action recommendations, and whether the first individual is of a particular gender. A particular group action recommendation from the plurality of group action recommendations is selected. Based on the context of the group action and that the first individual is of a particular gender, predicted satisfaction values associated with the first individual are weighted more heavily than predicted satisfaction values associated with the second individual during the selecting. The context may be determined, for example, by determining which user interface or application a user used to request a group action recommendation or which user interface or application will be used by the recommendation engine to display the group action recommendation. For example, if a user requests a group action recommendation through a dating application, the group action may be inferred to be a date and, as a result, the predicted satisfaction value of the female individual may be weighted more heavily than the predicted satisfaction value of the male individual.

In some embodiments, a recommended time for the group action is determined based on information relating to the two or more individuals and the group action recommendation identifies the recommended time for the group action. In other embodiments, the group action recommendation may not identify a time for the group action.

In some embodiments, a plurality of group actions is determined, based on the information relating to each of the plurality of individuals. The plurality of group action recommendations are caused to be presented at a plurality of devices including the device associated with the particular individual. Votes for one or more group action recommendations of the plurality of group action recommendations are received from one or more devices of the plurality of devices. Based on the votes for the one or more group action recommendations, at least one particular group action recommendation is selected from the plurality of group action recommendations. Then, at least one particular group action recommendation does not include all group action recommendations of the plurality of group action recommendations. In response to selecting the at least one particular group action recommendation, a message is sent to the device identifying the at least one particular group action recommendation.

In some embodiments, based on the information relating to each of the plurality of individuals, a plurality of group action recommendations determined and caused to be presented at a plurality of devices including the device associated with the particular individual. Down votes for one or more group action recommendations of the plurality of group action recommendations are received from one or more devices of the plurality of devices. Based on the down votes for the one or more group action recommendations, a particular group action recommendation is caused to be presented at the device in place of the one or more group action recommendations, where the particular group action recommendation is different from the plurality of group action recommendations.

In some embodiments, a confidence level is selected based on information relating to the plurality of individuals, where each confidence level of a plurality of confidence levels is associated with different text for recommending the action. The group action recommendation comprises text associated with only the selected confidence level. The confidence level may be selected based on a level of certainty a recommendation engine has that the plurality of individuals will approve of the group action recommendation or that the plurality of individuals will be able to participate in the group action at the recommended time or otherwise based on their schedules. The confidence level may be indicated by an explanation that identifies the recommendation or is otherwise displayed in association with the recommendation, such as an explanation that states “You should try this because the group has fifteen (15) friends who enjoyed this place.”

In some embodiments, it is determined that one or more certain devices are in close proximity to a particular device. Based on the determination that the one or more certain devices are in close proximity to the particular device, it is determined that the group comprises individuals associated with the one or more certain devices and an individual associated with the particular device. The group action recommendation is selected based on information relating to individuals associated with the one or more certain devices and the individual associated with the particular device.

In some embodiments, notification of a request to view a next channel on a television is received. A channel is selected based on information relating to each of the two or more individuals. In response to receiving the notification, the channel is displayed on the television.

In some embodiments, a request identifying a group action associated with the group action recommendation and requesting recommendations for participants of the group action is received from a particular device. Participants for the group action are selected based on information associated with each individual of the plurality of individuals. The group action recommendation identifies the participants, namely the two or more individuals.

In some embodiments, a request identifying the two or more individuals and requesting a recommendation for a group action is received from a particular device. The group action recommendation is selected based on information associated with the two or more individuals. The group action recommendation identifies the group action.

According to another embodiment, a computer determines that a group action is planned for a group that includes at least a plurality of individuals including a particular user. A recommendation for an item relating to the group action is determined based on information relating to each of the plurality of individuals. The recommendation for the item is presented at a device associated with the particular user.

In some embodiments, the item is one or more of an activity to perform in preparation of the group action, an activity to perform during the group action, an item to experience during the group action, an item to use during the group action, or an item to bring to the group action.

In some embodiments, based on information obtained from a third-party application, it is determined that the group action is planned for the group that includes at least the plurality of individuals including the particular user.

In other embodiments, a computer system comprises one or more processors and or more non-transitory computer-readable storage media store instructions which, when executed by a processor, cause performance of one or more of the methods described herein.

In certain embodiments, a group recommendation engine, which is executable on computer hardware with electronic access to data relating to a plurality of group members, comprises storage for recommendation rules. A recommendation rule maps one or more preferences to one or more outcomes. The group recommendation engine also comprises storage for data representing actions that can be group recommendations to the plurality of group members and program code for processing the recommendation rules, data representing the actions, and preference data about two or more of the plurality of group members to determine a set of one or more group recommendations of an action for a group as a whole.

In some embodiments, the preference data comprises explicit preferences and implicit preferences.

In some embodiments, the action includes one or more of a purchase action, an attendance action, and/or an engagement action to be partaken in collectively by participating group members, wherein the action is optimized considering the group as a whole.

In some embodiments, the group recommendation engine is configured to be operated by a single member of the plurality of group members. In other embodiments, the group recommendation engine is configured to be operated by two or more members of the plurality of group members.

In some embodiments, the group recommendation engine further comprises program code for recommending membership for the plurality of group members.

In some embodiments, the program code for recommending membership for the plurality of group members further comprises program code for evaluating social graphs of group members.

In some embodiments, the recommendation engine is configured to execute on one or more of a computer, laptop, tablet or mobile phone device.

In some embodiments, the recommendation engine is configured to take into account one or more of weather data, parking availability data, traffic data, location and/or explicit expressed preferences of one or more of the plurality of group members.

In some embodiments, the recommendation engine is configured to take into account preferences of some group members who ultimately are not part of the group. For example, the recommendation engine may determine that preferences of certain group members are not compatible with the preferences of a target user that requested a recommendation. After analyzing the preferences of the certain group members, based on the determination that the preferences of the certain group members are not compatible with the preferences of the target user, the recommendation engine may chose not to recommend the certain group members as participants for a certain group action.

In some embodiments, the recommendation engine is configured to take into account a group context for actions before making a group recommendation. For example, the group recommendation engine may take into account information about each user in the group that will participate in the group action.

The group recommendation engine can take into account preferences of more than one person in recommending a group action. Examples of actions are provided herein, but the list provided herein is not meant to be exhaustive. A group action is an action (making a purchase, attending an event, engaging in an activity, etc.) that is performed as a group. The group recommendation engine runs using some computer hardware and data storage, in order to provide computed recommendations in suitable time.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments. Thus, while example embodiments are described, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

Additionally or alternatively, a group action recommendation engine may make recommendations about who should be a member of a group rather than providing recommendations of group actions. For example, if a user runs a group action recommendation engine and provides the recommendation engine with access to the social networks of a plurality of that user's friends, group action recommendation engine might make a recommendation (based on interests, weather data, location, etc., for example) of a kite flying activity and also make a recommendation of which of the user's friends the user might want to invite to participate in that group activity. One benefit of many such group action recommendation engines is that it is might be possible for the recommendation engines to uncover hidden synergies, such as illuminating a previously unknown common interest in kites among friends.

### 2. Structural and Functional Overview

2.1 Example Recommendation System

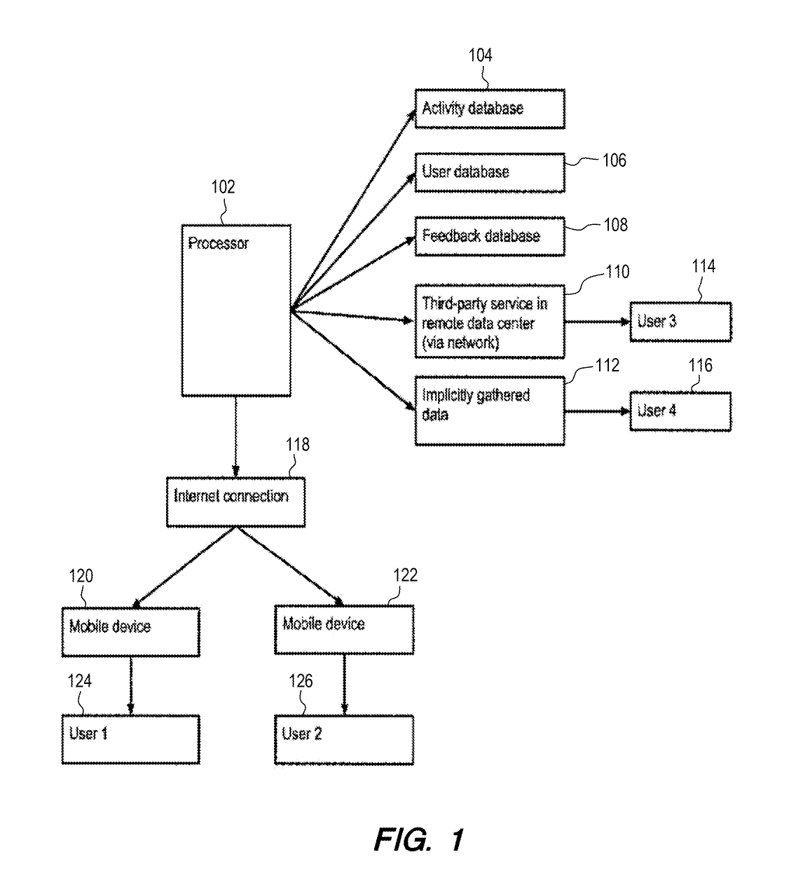

FIG. 1 illustrates an example personalized recommendation system. A device that contains processor 102 may comprise a recommendation engine that receives information from and sends information to one or more users, such as User 1 (124) and User 2 (126). The users may interact with the recommendation system through mobile devices or other electronics, such as mobile device 120 and 133. Users may transmit information to the recommendation system through the mobile devices and through the Internet using internet connection 118, wireless networks, or any other suitable network. In some embodiments, the system may be distributed in the form of services running in remote datacenters that exchange information with end-user electronics. In other embodiments the system may operate in a local area, for example with all parts in a single house.

Data such as user preference information and entity data information may be in a remote datacenter or stored in a mobile device (e.g. a phone) or in an immobile device (e.g. a TV set or thermostat). The recommendation system may operate through an application installed on a general-purpose device, like a smartphone or TV app. For example, a mobile or desktop application may communicate with a recommendation engine located at a separate location, such as at a remote server, or the recommendation engine may be a component of the application itself.

Examples of mobile devices are laptop computers, netbooks, ultrabooks, tablets, smartphones, wearable computers, glasses, contact lenses, implanted devices, and computational devices embedded in clothing. Mobile devices also include mobile software or user interfaces for remote software (for example, web browsers) that can be used by a mobile user even without the physical transport of a mobile hardware object. Recommendation apps, which may communicate with a remote recommendation engine or include the recommendation engine, may be installed on mobile devices 120 and 122.

The recommendation engine may be communicatively coupled with a plurality of data stores that contain information relating to different individuals. The recommendation engine may select a group activity and/or participants for the group activity based on information in the plurality of data stores.

Activity database 104 describe activities performed by the different individuals, such as indications of movies the individuals have watched, items the individuals have rated, what the ratings have been, comments made by the individuals, pictures of the individuals and other activity information described herein.

User database 106 includes representations of affinity graphs that describe relationships between individuals and other entities, demographic information, and other user information. Feedback database 108 includes individual feedback relating to previous recommendations by the recommendation engine, such as whether an individual approved of a particular recommendation.

Third-party services in remote data center 110 include services, such as music services or social networking services that provide user preference information (e.g. favorite music, favorite author), user activity information (e.g. recent check-in or status updates), or other user information to the recommendation engine for use in selecting a recommendation relating to a group activity.

Implicitly gathered data 112 includes information implicitly determined about the individuals based on other information available to the recommendation engine. For example, implicitly gathered data 112 may include implicit user preferences that the recommendation engine infers based on other information received by the recommendation engine about the user.

Some users, such as User 1 (124) and User 2 (126), are customers of the service using the recommendation engine and may have mobile devices connected to the recommendation engine. Other members of the group, such as User 3 (114) and User 4 (116), are not customers of the service, yet data about their preferences is available from a third-party service that they are customers of or that is inferred by the system from other sources (such as a combination of third-party data and data from the mobile devices of Users 1 and 2). Such information may be stored in data stores 110 and 112. Based on information in data stores 110 and 112, the recommendation engine selects group actions that are likely to be of interest to Users 1, 2, 3, and 4 as a group activity, and causes the recommendation for the group to be presented to Users 1 and 2 through their mobile devices (e.g. 120 and 133).

2.2 Example Recommendation Process

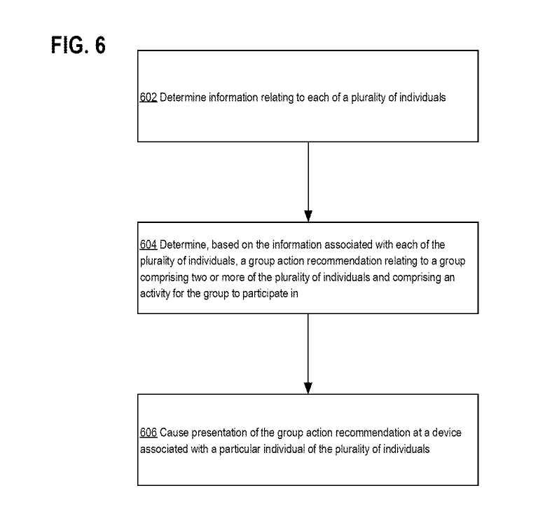

FIG. 6 illustrates an example process for determining and presenting a group action recommendation. The process illustrated in FIG. 6 may be performed at a recommendation engine. At block 602, the recommendation engine determines information relating to each of a plurality of individuals. At block 604, the recommendation engine determines, based on the information associated with each of the plurality of individuals, a group action recommendation relating to a group comprising two or more of the plurality of individuals and comprising an activity for the group to participate in. The group recommendation engine may select the two or more individuals from the plurality of individuals as participants to recommend for the group activity.

For example, based on information about certain individuals of the plurality of individuals (e.g. preference information, calendar information, or location information) the group recommendation engine may determine that the certain individuals would not enjoy the group action or would not be able to participate in the group action due to other commitments or inferred or actual location. As a result, the recommendation engine may recommend two or more individuals, which are different than the certain individuals, to participate in the group action.

In other embodiments, the user may identify the participants for a group action and may identify the participants to the recommendation system before the recommendation engine selects a group action.

At block 606, the recommendation engine causes presentation of the group action recommendation at a device associated with a particular individual of the plurality of individuals. The particular individual may be, for example, an individual that requested a recommendation or a leader of the group action. In some embodiments, the recommendation action may cause presentation of the group action recommendation at a plurality of devices that are associated with different individual (e.g. the recommended or user-identified participants of the group action).

A request may be expressly provided by the user or inferred. For instance, a user may specify a desire to watch a movie; or a system may infer that the user would like to watch a movie based on past activity of the user or other users or current activity of the user. For example, the recommendation engine may determine that a particular user would like to watch a movie based on a determination that the particular user is located near a movie theater and that friends of the particular user are located inside the movie theater.

An inferred request or parts of it may be articulated to the user in a way that allows the user to alter the inferred request.

In addition to identifying a group action, the group action recommendation may also identify each individual included in the group to which the group action recommendation pertains. Individuals may be selected for inclusion in the group based on how closely an individual is related to a particular target user or other individuals included in the group. For example, the recommendation engine may only select a particular individual for inclusion in the group to which the group action recommendation pertains if the particular individual is connected to the user running the engine through at most two hops in a social graph. In other embodiments, the recommendation engine may recommend a group action for a group of previously unconnected individuals.

As used herein, the “target user” of the group recommendation engine is the person who initiates a recommendation process, but there might be situations where multiple members simultaneously initiate the recommendation process. An example of the former is where one person starts a group recommendation engine app and uses it to find a restaurant for a birthday party at a later date. Then, via the app or other communications channels, that recommendation is propagated to invitees (i.e., other members or potential members of that group). An example of the latter is where three friends are undecided on a restaurant selection, but all bring their smartphones into proximity with the others, the recommendation app senses this, builds a group membership according to which smartphones were detected, and then makes a group recommendation to the group as a whole based on information about each of the individuals in the group.

When a recommendation involves multiple people, a system may enable one user to indicate a desire to engage in a particular activity, and request that the system recommend someone to do it with; or enable one user to indicate a desire to do something with a particular person, and request the system recommend an activity; or enable a user to receive a recommendation without specifying either. The users may be known to each other beforehand or unknown. For example, the system might recommend that one user meet with seven other persons not previously known to each other for a neighborhood game of soccer.

In embodiments where the user requests a recommendation, the user may provide hints that the recommendation engine uses to select a recommendation. For example, the user may indicate he wants recommendations for a group activity for some time next week, during a weekday evening. As another example, the user may indicate he wants something out of his comfort zone, and the recommendations engine may select an item or activity that the user has not previously experience. As yet another example, the user may specify a preferred price range for the recommended activity or other item.

In some embodiments, the recommendation engine may first specify one or more group activities and, based on the one or more group activities selected or approved by the user, the recommendations engine may recommend other individuals with whom the user may perform the group action with. The individuals recommended as participants for a group activity may, in some embodiments, be selected based on a determination that the user would enjoy the group activity. In other embodiments, the recommendations engine specifies the recommended participants for a group activity together with the first presentation of the group activity recommendations to the user, rather than selecting participants after the user has indicated his approval of a particular group action recommendation.

2.3 Information Used to Select a Group Action Recommendation

The recommendation engine may use any combination of the information described herein to select a group action for recommendation, to select users for inclusion in the group to which the group action recommendation pertains, or to select an item for recommendation for a previously planned group activity.

Not all of the members of the group need to be users of the recommendation engine, but if the recommendation engine is going to take into account some data about a particular individual in making a recommendation, the recommendation engine would need access to some data about that particular individual. Users of the recommendation engine might use a user interface, such as on a computing device (computer, laptop, tablet, phone, or other computing device or means), to provide explicit user preferences. Users might also provide the recommendation engine access to data about the users to allow the recommendation engine to determine implicit information about the users. With multiple members of a group, the recommendation engine can optimize recommendations over the group, rather than independently providing recommendations in isolation to each member of the group.

The recommendations may be based on explicit user preferences. The recommendation engine app may cause display of a computer-user interface that asks a user a series of questions (e.g., “Do you like rock music?”, “Do you enjoy opera?”, “Do you like really spicy food”, “Does a view matter when choosing a restaurant?”, “Do you like the outdoors?”) and tracks the user's responses. Examples of implicit user preferences might be a recommendation engine inferring that the user likes water views and coastal environs because the user calendar data to which the user has provided the recommendation engine access shows a scuba outing at least once a month.

Which entities are presented may take into account signal data relevant to the user and/or a particular request. As an example, suppose two people are planning to meet for a meal at a restaurant. The system may take into account data on the taste preferences of each individual, the known or likely location of each individual, either currently or at some time in the future, and any additional special contexts such as, for instance, that it is the anniversary of a married couple as noted on one of their calendars or in a social network that one of them belongs to.

Signal data may be inferred, provided to the system explicitly or implicitly, or obtained from other sources. In addition to location and time, examples of signal data include affinity graphs, demographic data, information about individual intention, information from mobile devices, and transactional data. It should be understood that signal data can be represented by physically stored data representing the signals, stored in a manner that can be read, updated, erased, and/or sensed by a processor, circuit, or the like.

Affinity graphs represent relationships between users and entities, or between users and other users, or between entities and entities, or some combination thereof. The users or entities represented in the affinity graph may include users who are not the end users of the recommendation system and entities that are not the entities subject to recommendation. An affinity graph may provide a model of affinity between users and other users, or between users and entities or other objects, in general or with respect to an attribute of interest. An edge of an affinity graph may indicate a relationship between users, such as a user following another user on a blogging service, or may indicate a liking or disliking for a kind of food. Edges may have weights indicating strength of a relationship, such as the extent to which a person trusts a doctor's expertise.

Affinity graphs may be augmented with additional information such as attributes of entities (like the primary cuisine type of a restaurant), short-form textual messages, pictures, financial transactions, check-ins or other explicit or implicit annotations used to denote that a user has visited or prefers a location, and explicitly tagged content. The affinity graph may be constructed by people choosing to link themselves to other nodes or by aggregation and analysis methods that infer the links and weights. For instance, an edge may be inferred based on a determination of who sends messages to who in a social network or a weight on a preexisting edge between two people may be inferred based on whether the two people send messages, how often they send messages, or the type of messages they exchange. It should be understood that constructs such as an affinity graph are often implemented using data storage and programming code designed to read and interpret stored data in a particular manner. For example, a smartphone processor might have a data structure stored in memory that represents the affinity graph, such as a table of nodes, a table of links, and other data as needed to allow the processor to walk and read the affinity graph, its nodes, its edges, its weights and other pertinent data.

Recommendations may also be based on what the demographics of the plurality of individuals are. Demographics may include gender, ethnicity, income, height, weight, age, and other information but is not limited to them. Demographic data may be inferred.

The system may take into account intention data described in or inferred from data not expressly provided by the user. Intention may be explicit or implicit. Examples of explicit intentions include when the user specifies “I want to give Jane Doe a gift,” or the user indicates a hatred of Italian food or horror films, or the user specifies that the user does not care what his friends think. An example of implicit intention determined by the recommendation engine is when the recommendation app evaluates public or private messages, location data, transactional history, demographic data, and personal calendar data to infer the user will soon wish to buy a gift for his wife because her birthday is coming up. Intention can also be inferred using data on the user's emotional state.

Transactions include explicit transaction data such as credit card, loyalty program, and point of sale data. It also includes information inferred about transactions through a person's location and messages. For example, if a person is in a venue for paid entertainment it may be inferred that someone paid for a ticket. If it can be further inferred that the person in the venue did not pay for the ticket, this discloses further information about the existence of a third party and their possible relationship. For example, a system may be able to infer that a person attends one kind of restaurant when on business for which her employer pays, and another kind when she pays herself. Transaction data may further enable inferences about location, price sensitivity, or brand or merchant affinity.

Other relevant user activity can include explicit and passive signals. Explicit signals include user-provided ratings and sharing on the service or on third-party services. For instance, a music application may use preferences from another music service. Ratings generally can include overall evaluations of the quality of an item, or specific dimensions such as taste and price. They may come in a variety of forms, such as discrete (e.g., a 5-star rating scale), logical (true or false), descriptive (short comment), pictorial (e.g., a representative photograph or drawing), auditory, gestural (e.g., a swipe up or down), or visual (e.g., an interpretive dance) form. In some cases sentiment analysis may be used to extract meaning from natural-language text. For example, the word “yucky” may be treated as meaning, with regard to a particular dish, a bad rating on a taste dimension. Passive signals include how far into a particular movie or TV show they watched, how many hours they played a game, or inferences about what they did at a physical activity based on data from a device such as a wrist-attached fitness-tracking electronic device.

Information about intention, transactional data, and affinity graph data may enable estimates of parameters related to an item that may be presented. For instance, rating data on a five-star scale or transactional data may allow estimates of sentiment towards an item, or frequency of contact with an item, which in turn can be used to select a recommendation or participates for a recommendation.

In addition to including signal data that is provided explicitly by a user and signal data that is inferred, combinations are possible. For instance, the system may ask the user to confirm a generalization of passive signals, asking a user who never listens to country music whether the system should avoid recommending that genre.

Examples of information that may be derived from mobile devices include location, temperature, or acceleration (e.g., through a GPS unit or an accelerometer). Data can be gathered from mobile devices and combined with other information. For instance, data about weather or traffic may be inferable from multiple mobile devices or may be obtained from other sources and combined with data from mobile devices.

In some cases, the group recommendation engine takes into account group dynamics that it is aware of. For example, if the recommendation engine knows that a user is currently on a business trip, it might make one group recommendation for a given time, location, preference, but if the recommendation engine knows that a user is currently on vacation, it might make a different group recommendation for that same given time, location, preference set, etc.

The recommendations engine may determine whether the user is on a business or personal trip based on, for example, an analysis of calendar information associated with the user, information that the user has shared on a social network, or the user explicitly identifying to the recommendation system the nature of the trip.

The recommendations may be based on the locations of the plurality of individuals.

The system may detect who is present using Near Field Communication (NFC), Bluetooth, GPS triangulation, common wireless networks, or similar methods. For example, location data may be used to determine who is present at a particular location. The selection of the group action or the selection of an item related to a planned group activity may be based on information relating only to individuals that are present at a particular location.

The recommended group action, the recommended participants of the group action, the recommended item related to a planned group activity, and/or a recommended time for the group action may be selected based on the locations of the plurality of individuals. For example, the recommendation may determine who is present at a particular location and, based on the determination, may select a song to play. The recommendation engine may instruct a music system to start and to play the music that is likely to be relevant to all of the individuals present. In another example, the system may incorporate data on the current location of participants, using the fact that two are near each other and one is not, or that one is traveling to select recommended participants for the group action. As another example, the system may determine that a group should preferably meet for drinks at a location in between one group member's workplace and a second group member's home. As yet another example, location may enable a lookup of weather data to determine whether an outdoor activity is advisable.

In some embodiments, the current or future location of particular users may be determined or forecasted based on an evaluation of known previous locations of the particular user at similar times. For example, if the recommendation engine determines that for the past ten (10) Friday afternoons, the particular user has always been in San Francisco, the recommendation engine may assume that the user will be in San Francisco on an upcoming Friday afternoon. On that basis of that determination, the recommendations engine may select San Francisco as a location for a planned group activity for which the particular user is a participant or the recommendation engine may recommend the particular user as a recommended participant for a group activity occurring in San Francisco. In other embodiments, the inferred location of a particular user may be more granular. For example, in other embodiments, the recommendation engine may determine that the particular user is likely to be in a particular restaurant or other location in San Francisco or another particular city.

Context affecting a recommendation can combine any or all of the data available to the system. For example, based on each of the time of day, individuals present, and location, the recommendation may engine may determine that each of the plurality of individuals are sitting on a couch at 8:00 PM and that it would be appropriate to recommend a TV show to watch as opposed to recommending an outdoor activity.

Affinity graph or other data may encompass relations between users in a group to whom recommendations are presented or with regard to which recommendations are made. This may be relevant to recommendations provided.

For example, in addition to attempting to present entertainment that is satisfactory to both users, the recommendation engine might take into account a social dynamic that two users are close friends to select a particular recommendation. For example, the recommendation engine may choose to recommend visiting a restaurant that serves a multi-course meal or some other time-consuming activity only if each of the participants is close friends with the other participants or with the target user.

Interactions or relations between users may have different significance depending on the circumstances. For instance, a date and a work-related function may have different requirements for material recommended. This may be true even if two people are involved at each function and even if they are the same two people. This type of context may be expressly provided or inferred by the system. For example, if the recommendation engine infers that there is a romantic relationship between two individuals, the recommendation engine may only select an activity that that the target user has performed before when recommending a group action. The recommendations engine may determine that a planned event is a date and, as a result, may only recommend to a user a restaurant that the user has visited before. The recommendation engine may determine that a planned event is a date based on a determination that the two individuals participating in the planned event are in a relationship (e.g. based on social networking data identifying the two as being in a relationship).

In various embodiments, the system may use a catalog or database of entities that may have a fixed or variable number of attributes. In some cases a database will be constructed on-demand or entities will be based on temporary content obtained from a third party on demand, such that the data does not need to be stored. Examples of attributes that may augment an entity catalog includes price, hours of operation of a resort, ingredients of a dish, availability of parking at a concert, or the view of a stage for opera tickets. In some embodiments the entity data is derived from multiple data sources that are de-duplicated, resulting in a single higher-quality data set.

In certain embodiments, the recommendation engine may determine recommendations using techniques that are known in the literatures of statistics, artificial intelligence, and machine learning. A group action or participants may be selected based on how similar the ratings of one individual are to the ratings of another individual. As one example, an individual may be selected as a participant based on a determination that the individual rates different items similarly to how the target user or other participants rate the different item. An example of such a technique is using cosine similarity in an application where ratings are on a 5-star rating scale to determine how similar one entity's set of ratings is to another entity's set of ratings, and then to provide recommendations of the first entity based on the similarity. Methods such as Latent Dirichlet Allocation or (Non-Negative) Matrix Factorization may be used in an application where the ratings are combinations of one or more words like “yucky,” “tasty,” etc., to model the ratings as words associated with topics in a topic model. Another example of such a technique is using natural language processing to extract sentiment information from free-form textual statements related to an entity and using a collaborative filtering technique with the information thus extracted.

2.4 Example Types of Group Action Recommendations

Recommended group actions might include, for example, shopping together, buying an item together, going to an event together, or engaging some other activity together. Recommended entities may relate to any persons, items, or objects of interest that can be represented or referred to in a computer system, such as people, entertainment, travel destinations, retail merchandise, activities, or venues. In many cases, the recommendation relates to something that can be used or consumed such as a type of food or a travel experience. What recommendations the system produces for a user may depend on related data such as the location of the user, what activity the user is engaged in or will engage in, or the people who are or will be present.

Examples of entities that may be recommended include providers of goods and services, such as restaurants and nightclubs; particular goods or services, such as a dish at a restaurant or a concert; a document or a specific part of a document, such as text or musical compositions; a relationship or potential relationship between two persons, as in a dating application or doctor; or individual people.

Applications may relate to media and entertainment, such as movies, TV shows, radio shows, web serials, or music videos. For instance, the system may assist two users sitting on a couch in selecting a show to watch together. Two users can get a recommendation applicable to both of them, based on their past experiences watching TV and data the system has about their browsing habits. When users are watching live TV, the system may dynamically suggest channels or rule out channels. For instance, when two users are present and one presses a “next channel” button on a remote, the system may skip over channels and show the TV program both users are most likely to enjoy next, analyzing the channels available on their cable or other TV connection automatically.

Recommendations may involve activities that may be undertaken at home, like watching movies, playing electronic games, reading books, or using mobile device, TV, or computer apps; or activities that can be done outside, such as dances, plays, concerts, movies at theaters, exhibits, and outdoor activities. For instance, the system might recommend surfing at a good beach. As another example, the system might recommend a book club to go to or the next book that the book club should read given what they read before.

Content such as games, music, and video may be provided along with the recommendation system as a service. For instance, a single service may provide a variety of electronic entertainment options to a TV or console gaming system combined with recommendation services that select appropriate choices.

Other applications relate to travel. For instance, when a family is making plans to travel, the system may recommend a region to go to or specific merchants like hotels or restaurants to do business with. When users are already traveling, the system may point out attractions nearby automatically.

Other example applications relate to shopping. A group of users may be shopping together, and the system may advise them they should both go to a store. For instance, if everyone in a group likes high-end fashion, it may recommend a store that recently added a collection by a well-known designer. Alternatively a user may be shopping for future use or consumption in a group. For example, a system may recommend the best beer to buy for a party taking into account which individuals are expected to show up and what their preferences for beer are.

2.5 Recommendation Objectives

Generally, recommendations presented to a user may be selected with regard to a particular objective function or goal of the recommendation system. For example, the objective function may be to accurately estimate how highly one or more user are likely to rate an entity overall and present entities with a high predicted rating. In such a system, the entity and the predicted rating may be provided together. However other objectives are possible. For instance, a prediction system may have goals such as maximizing how long one or more users will stay on a channel before changing the channel, leaving, or turning off the TV; maximizing entertainment value; increasing customer satisfaction or retention; maximizing advertising value; or optimizing a financial goal such as profitability.

Where multiple objectives are present (such as customer satisfaction of multiple customers) they may be combined. A system may attempt to maximize the satisfaction of the least satisfied user, attempt to “satisfice” an inferred utility function (that is, attempt to reach a certain level of utility with reference to a utility function without necessarily optimizing beyond that point), or attempt to maximize a weighted average or combination of user utilities.

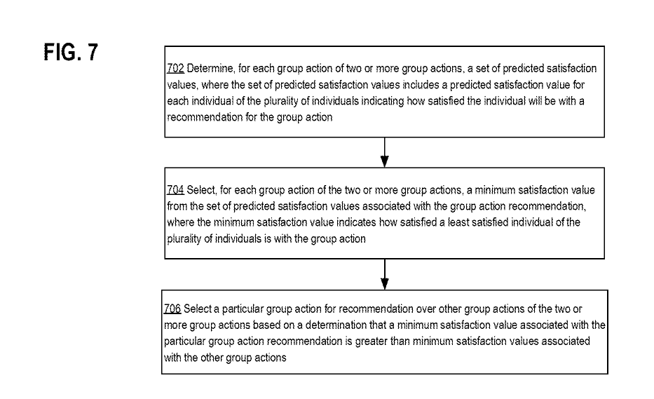

FIG. 7 illustrates an example process for selecting a group action to recommend from among a plurality of group actions with an objective of maximizing the satisfaction of the least satisfied user. The process of FIG. 7 may be performed at a recommendation engine. At block 702, the recommendation engine determines, for each group action of two or more group actions, a set of predicted satisfaction values, where the set of predicted satisfaction values includes a predicted satisfaction value for each individual of the plurality of individuals indicating how satisfied the individual will be with a recommendation for the group action.

At block 704, the recommendation engine selects, for each group action of the two or more group actions, a minimum satisfaction value from the set of predicted satisfaction values associated with the group action recommendation, wherein the minimum satisfaction value indicates how satisfied a least satisfied individual of the plurality of individuals is with the group action.

At block 706, the recommendation engine selects a particular group action for recommendation over other group actions of the two or more group actions based on a determination that a minimum satisfaction value associated with the particular group action recommendation is greater than minimum satisfaction values associated with the other group actions. As a result of selecting the first group action over the other group actions, the recommendation engine may, for example, display a recommendation for the first group action before recommendations for other group actions. In another embodiment, the recommendation engine may not display recommendations for the other group action recommendations at all.

FIG. 7 illustrates merely one example approach for selecting a group action from a set of group actions for recommendation based on the predicted satisfaction values of a plurality of individuals. In other embodiments, the recommendation engine may select a group action on a different basis. For example, the recommendation engine may attempt to maximize a weighted average of prediction selection values instead of maximizing a minimum satisfaction value during the selection of a group action. A weighted average of predicted satisfaction values may be determined for each group action of a plurality of group actions, where the predicted satisfaction values of certain individuals (such as a guest of honor or an initiating user) are weighted more heavily than the predicted satisfaction values of other users. In such an embodiment, the group action with the highest weighted predicted satisfaction value may be selected for recommendation.

Interactions between users and the system may change dynamically depend on location, user action, and/or activity under way. For example, as people arrive at or leave a party or room in a nightclub, music can automatically change to take into account the preferred genres of people present.

In an embodiment, the recommendation engine determines a predicted satisfaction level for each participant of the group for each of a plurality of potential actions or other items. The recommendation engine may compare the satisfaction level of the least satisfied participant of the group for each of the plurality of actions or items, and may select the action(s) or item(s) for which satisfaction level of the least satisfied participant is highest. The selected action(s) or item(s) may be the only actions or items recommended or may be recommended before other action or items.

Part of the objective may incorporate a cost measurement of an item. This may be a cost paid for by the user or group of users or a cost paid by another, such as a royalty paid by the operator of an integrated content-and-recommendation service for media content. Part of the objective may incorporate the value to the service provider.

In some embodiments the recommendation engine may try to select a recommendation for a group action involving multiple users, where user satisfaction or objective functions may be different depending on one user's role in an interaction or relation to another user. For example, when the recommendation engine determines that children and adults are both present, a system may select only child-applicable media rather than attempting to select media that is in between the ideal child media and the ideal adult media. As another example, at a work-related function, work-appropriate recommendation (such as a recommendation for media) may be selected even if all or almost all users prefer work-inappropriate media.

User satisfaction or objective functions may be weighted differently depending on one user's role in an interaction or relation to another user. Thus, in some embodiments, the recommendation engine first determines one or more individuals' roles in an interaction or relationship between multiple users and uses the determined information to select a particular action or other item to recommend.

For example, at a date, an activity may be selected that is designed to let one user impress the other, purposely placing a lower value on the first user's satisfaction with the activity. The system may determine which of the two participants is female and may assign a greater weight to the predicted satisfaction value of the female when selecting a group action recommendation.

As another example, a particular individual may be designated as being the guest of honor, for example if the event is being planned to celebrate the particular individual's birthday. The recommendation engine may select a recommendation based on a determination of which recommendation would be most satisfactory to the particular individual. In other embodiments, the system may attempt to maximize the satisfaction of an individual that initiated the recommendation or an individual that is designated as leader of the group action. The recommendation system may determine who the guest of honor or designated leader is based on user input or other user information accessible to the recommendation system, such as calendar information.

In some embodiments, the recommendation engine may select a recommendation based on information relating to a plurality of individuals participating in the group action but may assign a higher weight the satisfaction of a particular individuals as compared to the other individuals in the plurality of individuals.

2.6 Presentation of Recommendations Relating to Group Actions

A recommendation may be presented to a single user in a way that takes into account the presence, desires, goals, or other relevant data of other users, or may be presented to multiple users in the same way or at the same time.

Multiple entities may be presented to a user, or only one. In embodiments, where multiple entities are presented, multiple entities may be presented at the same time, or each entity may be presented individually at separate times. For example, in a jukebox application a single entity may be presented at a time, where the entity is a song and the presentation occurs by playing the song. The recommendation system may maintain a playlist and enable users to either allow it to automatically play items or modify or give feedback to the recommendation system about the playlist to the system. In another example, multiple entities are represented on a TV screen and the user may select one or give feedback about the quality of recommendations, such as by dismissing one item as a bad recommendation.

During presentation of group recommendations, one user or multiple users may be involved. Recommendations may be presented with explanations about why they may be relevant to a particular user or to the group, where the explanation depends on data about the users involved. Items may be presented to users at the same time, as in the case of a jukebox application that automatically plays music, or asynchronously, as in the case of a coordination system designed to help users pick a place to have beer at.

More generally, coordination systems enable a group to coordinate their activities. The coordination system may be an integral part of the interface of the recommendation system. In an embodiment, the system identifies a particular member of the group as managing the operation of the system. For example, one user may construct a list of possible activities from among the activities recommended to him by the recommendation engine, and send to other users a link to a Web page on which other users can add or remove items. As another example, users may be in each other's presence and the system may detect this based on proximity of their phones to each other, or to a particular device. Based on the detected proximity, the same recommendations may be displayed to each of the devise in proximity.

In an embodiment, the coordination system presents a series of options to vote on at the devices, where the system allows all of the users to vote at once. As they vote, the system narrows down the selections. For example, the coordination system might determine that the group is tending towards cheaper, quicker restaurants and away from expensive restaurants and, in response, may display recommendations for cheaper and quicker restaurants.

In another method of operation, one user selects three options and everyone else can vote to determine the favorite among those three only. Another method is for one user to select a small number of options and then receive from the system additional suggestions based on this small set of initial choices.

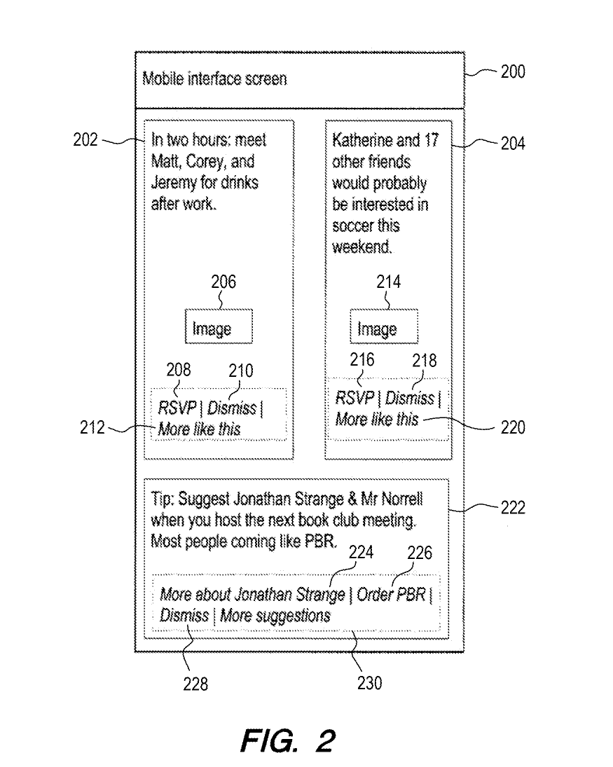

FIG. 2 is an example of an interface 200 displaying both group action recommendations and a recommendation for an item relating to a planned group activity. Interface 200 may display automatically without a user entering a search query (e.g., in response to the user launching the recommendation app) or may display in response to a user entering a specific search query.

Interface 200 may be presented at a device associated with a user of the recommendation system. Interface 200 identifies multiple activities that the user may choose to engage in where the time at which the activity occurs and the specific group of users of interest is not necessarily the same for each activity. Recommendation 202 specifies an activity of “drinks”, at a time of “after work,” and also identifies participants “Matt, Corey, and Jeremy.” The participants may have been specified by a user or may have been automatically selected by the recommendation engine. The recommendation engine may have selected the time based information such as predicted or known current or future location of the participants, predicted weather information, or calendar information for the participants.

In some embodiments, after selecting the group action, item, and/or participants to recommend, the recommendation engine may select text that identifies the recommendation based on the amount or type of information the recommendation engine used to select to the recommendation. For example, text that indicates a medium degree of confidence may be selected based on a determination that the recommendation engine does not have access to each or any of the participants' calendars but does have certain type of information about each or some of the participants. In contrast, the recommendation engine may select text that indicates no confidence when the recommendation engine has access to each of the participants' calendars and also has access to certain type of information about each or some of the participants.

Recommendation 202, which states “In two hours: meet Matt, Corey and Jeremy for drinks after work” indicates greater confidence than recommendation 204, which states “Katherine and 17 other friends would probably be interested in soccer this weekend,” which indicates a medium level of confidence. The difference in indicated confidence levels may be caused by the recommendation engine having incomplete information about the schedule of the participants of recommendation 204 at the corresponding time (“this weekend”) and having complete information about the schedule of the participants of recommendation 202 at the corresponding time (“after work.”) The difference in indicated confidence levels may also or instead be based on a determination by the recommendation engine that Matt, Corey, and Jeremy are very likely to enjoy or otherwise approve of the group action of “drinks,” whereas Katherine and/or some combination of the 17 other friends are somewhat likely to enjoy or otherwise approve of the group action of “soccer.”

The determination of how likely the users are to like the group recommendation may be based on any combination of a variety of user information described herein including, but not limited to, preferences of the participants, demographic data relating to the participants, and activities performed by the participants, such as previous ratings or comments by the participants.

Factors that may impact the recommendation engine's selected confidence level for displaying a recommendation may also include, but are not limited to, the amount or type of user data used by the recommendation engine (e.g. the percentage of participants whose status updates the recommendation engine has access to) or a determination of how reliable the data used by the recommendation engine is.

The system may include images (206 and 214) or videos for each activity that may inform the user about what the activity would be like. By selecting option 208 or 216 titled “RSVP”, a user may indicate to the recommendation system that he plans to participate in the group activity. In response to receiving the selection of option 208 or 214 from a device associated with a particular user, the recommendation system may notify other participants of the group action. The recommendation system may also notify other participants that the particular user has confirmed he or she is attending the group action recommended by the group action recommendation. The participants may be the individuals specified by a target user, the participants selected for recommendation by the recommendation engine, or only participants that have confirmed they are attending the group action recommended by the group action recommendation. The notification may be sent via a Short Message Service (SMS) text message or may be displayed within instances of the recommendation app running on the respective devices of the participants. In some embodiments, in response to receiving a selection of the RSVP option, the recommendation system may notify a third-party scheduling system. In response to receiving the notification, the third-party scheduling system may send, within the third-party application, an invite for the particular group action to the other participants or reply accepting an invite for the particular group action. The reply may be sent to all other participants or a user that initiated or is otherwise organizing the group action.

A user may provide feedback to the recommendation system by selecting option 210 or 218 titled “Dismiss” or option 212 or 220 titled “More like this.” In response to receiving a selection of option 210, the recommendation system may display a different recommendation in place of recommendation 202. Future recommendations to a particular user may be selected based on the particular user's feedback regarding previous recommendations.

Recommendation 222 makes a suggestion about how to best enjoy an activity that the recommendations engine knows the user is already going to attend, for example based on the user's calendar or a previous piece of feedback made to the recommendation engine. The suggestion may be based on information available to the recommendation engine about the reading and beer-drinking preferences of people attending. The embodiment depicted is connected to an e-commerce beer-ordering engine that enables the user to order Pabst Blue Ribbon (PBR) beer directly from the mobile interface when option 226 titled “Order PBR” is selected. By selecting option 224, the user may view more information about the author Jonathan Strange. By selecting option 228, the user may dismiss recommendation 222 and provide feedback to the recommendation system. By selecting option 230, the user may receive additional recommendations from the recommendation engine.

The item recommended in relation to a planned event may be an action to perform during the event or in preparation for the event. For example, based on a determination that the user is attending a particular professional event, the recommendation engine may recommend a particular type of dress based on information about the other participants of the professional event. The recommendation engine may select the particular item to recommend for a planned event based on the type of planned event. For example, based on a determination that a user is attending a social event, the recommendation engine may select a food or beverage to recommend and based on a determination that the user is attending a professional event, the recommendation may select a clothing item to wear or a conversation topic to mention.

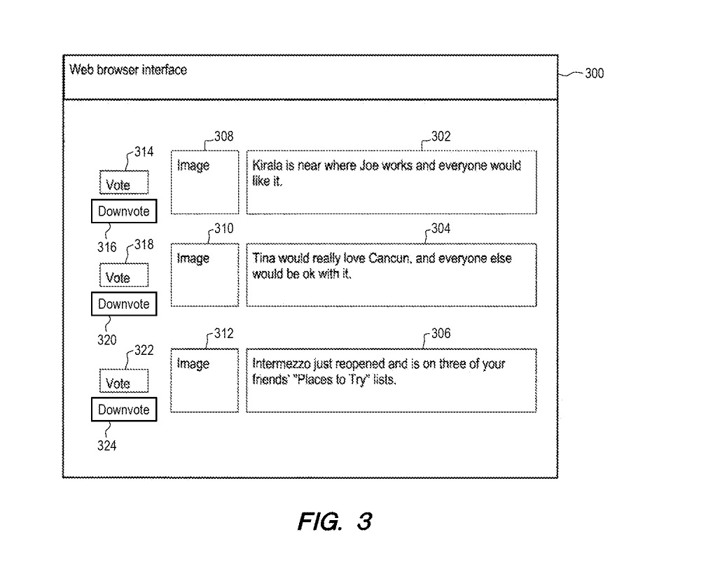

FIG. 3 is an example of an interface 300 displaying multiple group action recommendations and requesting feedback to enable coordination between different individuals of a group. In the embodiment depicted, the recommendation engine provides assistance to a specific group of users who are deciding where to eat for dinner. The recommendation system makes recommendations and users asynchronously review information about the recommendations and explanation data about why the recommendations are made, and provide feedback through a “voting” user interface element in association with the recommendations. As the system receives more data, it improves the suggestions until a member of the group (in some embodiments, a designated organizer of the group) selects a suggestion as the final decision.

Users may indicate approval of recommendations 302, 304, and 306 by selecting respective vote options 314, 318, and 322. In contrast, users may indicate disapproval of recommendations 302, 304, and 306, by selecting respective down vote options 317, 320, and 324. Images 308, 310, and 312 may depict the corresponding recommendations. In other embodiments, interface 300 may only display options to vote for recommendations and no options to down vote recommendations.

In some embodiments, the recommendation engine may not have access to information about one or more users who will participate in the group action. Thus, the recommendation engine may not take information about the one or more users into account when recommending a group action but such users may still to vote for the group action recommendations.

A coordination system may receive votes and/or down votes from each of the individuals that belong to a particular group and may select a particular group action from among a variety of recommended group actions based on the voting information received. For example, the coordination system may filter out each group action that received a down vote and may select, from the remaining group actions, the group action that received the most up votes.

In another embodiment, the recommendation may present information summarizing the received votes to a user that requested the group action recommendations or is designated a leader of the group action recommendation. For example, the recommendation engine may rank the group action recommendations based on the received votes and may display the ranked list at a device associated with user.

The list of group actions displayed to each user in the group may change based on the received votes and/or down votes. For example, in response to any individual in a group down voting a group action recommendation, the recommendation system may discontinue recommending the down voted group action recommendation to all individuals in the group and may recommend a different group action recommendation in place of the down voted recommendation.

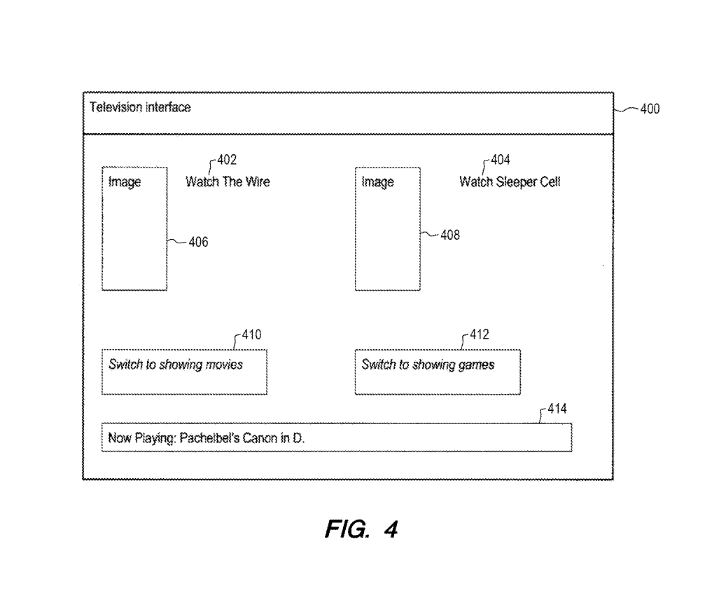

FIG. 4 is an example of a TV console interface 400 displaying group action recommendations determined by a recommendation engine. Recommendations 402 and 404 may identify television series recommended for a group that is determined to be watching a television upon which interface 400 is displayed or is otherwise associated with the device upon which interface 400 is displayed.

Images 406 and 408 may each be cover art or some other images associated with the corresponding television series. Using option 410, a user may switch to viewing recommendations for movies and, using option 412, the user may switch to viewing recommendations for games.

The embodiment depicted may use telemetry data from mobile devices held by users or facial recognition data from an attached camera) to determine which users it should provide recommendations about or for. The telemetry data received from a mobile device may indicate the location and orientation of the mobile device. Based on the received orientation and location data, the recommendation engine may infer that all users located less than a threshold distance from the television and oriented towards the television are facing the television and are watching television together. The recommendation engine may select a media item to recommend based on information associated with each individual in the group that is determined to be watching television together. The recommendation engine may send a message to the television that is near the group, which causes the television to play the recommended media item.

In another embodiment, the television itself may determine which devices are near the television using near-field communication or some other technology. The television may sense which mobile devices are near the television and send a message to the recommendations system identifying the nearby mobile devices.

The interface shown does not explicitly indicate who is in the room as determined by the recommendation engine or provide explanatory information about why a particular person in the room would be interested in watching a particular TV show, to avoid revealing personal information about user viewing habits. While the interface is not being used, it plays music that it estimates is likely to be liked by the users present. The interface may identify the music being played. For example, indicator 414 states that Pachelbel's Canon in D is now playing.

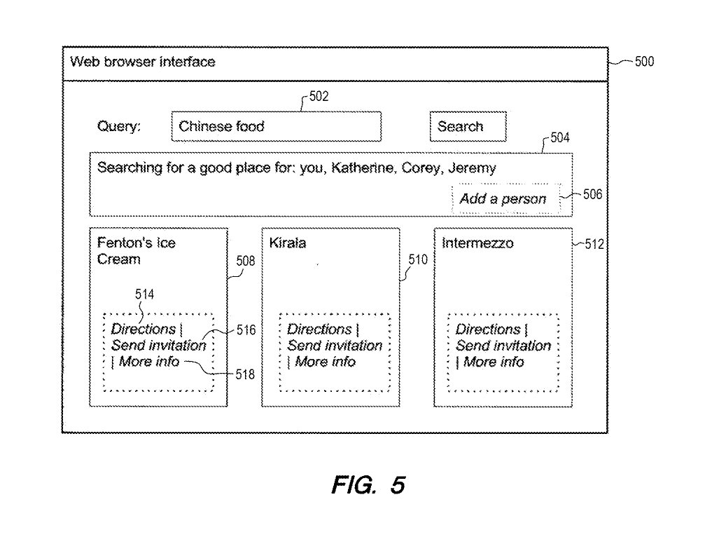

FIG. 5 is an example interface 500 using which users may provide input and request group action recommendations. In an embodiment, a single user operates the system without direct involvement from other users. A query UI element 502 allows the user to specify a query, such as “Chinese food.” An additional UI element 504 allows the person to specify additional people. As people are added with the “Add a person” UI element 506, the names of the specified people are shown in the user interface and the search results produced are updated to take into account the updated set of user data associated with the updated set of users.

Recommendations 508, 510, and 512 each identify a restaurant selected based at least in part on user information associated with the identified participant. The query results may have additional UI elements appropriate to a group recommendation context, such as the ability to send invitations (e.g. using element 516). In response to a user selecting element 516, invitations to the restaurant identified in recommendation 508 may be sent to the individuals listed in region 504. The recommendation engine may receive a notification of the selection of element 516 from the device. In response, the recommendation engine may cause a FACEBOOK event invite to be sent to the other individuals in the group. Alternatively, the recommendations engine may cause a link to a website using which the other individuals may respond to the invitation to be sent. In another embodiment, the recommendations engine may cause a meeting invite to be sent through a third-party scheduling application. By selecting element 518, a user may view more information about the restaurant identified in recommendation 508.

In some embodiments, the recommendation engine may cause presentation of a bundled of group action recommendation, where the group action recommendation identifies multiple group actions to be performed as a group and, in some embodiments, in a sequence. For example, a bundled group action recommendation may recommend that a particular group go to a particular location for drinks, a second particular location for dinner, and also visit a particular a concert.

2.7 Recommending an Item for a Planned Group Activity

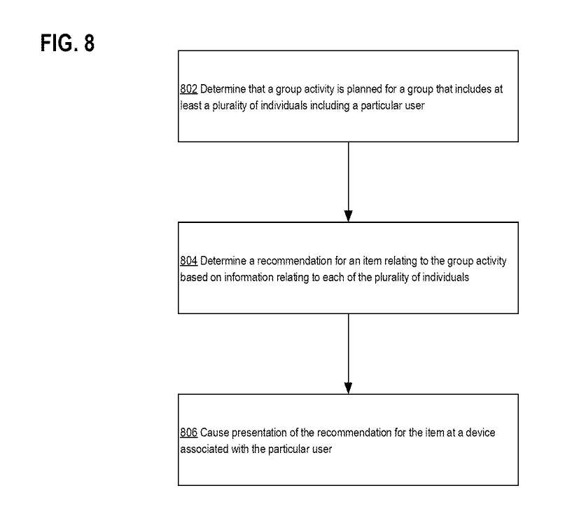

FIG. 8 illustrates an example process for determining and presenting a recommendation for an item relating to a planned group activity. The process illustrated in FIG. 8 may be performed at a recommendation engine. At block 802, the recommendation engine determines that a group activity is planned for a group that includes at least a plurality of individuals including a particular user. The recommendation engine may determine that a group activity is planned and may determine who is attending the group activity based on input from the particular user, other users of the recommendation system, or data associated with a third party-application. The third-party application may be one or more different applications used by the individuals belonging to the group such as one or more third-party scheduling applications. In another embodiment, the third-party application may be a particular application that aggregates data from other applications, where the individuals belonging to the group are users of the other applications but do not directly use the particular application that aggregates the data.

At block 804, the recommendation engine determines a recommendation for an item relating to the group activity based on information relating to each of the plurality of individuals. The information relating to each of the plurality of individuals may be any of the information described herein including, but not limited to, preference information, demographic information, location information, calendar information describing past or future appointments, feedback, social graph information, and other types of information, which may be stored in data stores 104, 106, 108, 110, or 112.

At block 806, the recommendation engine causes presentation of the recommendation for the item at a device associated with the particular user. Recommendation 222, which is described in further detail in the discussion of FIG. 2, is an example of a recommendations relating to a planned event.

The item recommended may include, but is not limited to, an activity to perform in preparation of the group action (e.g., for a social event where the host is the particular user, cook a particular dish), an activity to perform during the group action (e.g., at a book club, discuss a particular author or, at a restaurant, order a particular item), an item to experience during the group action (e.g., when visiting a museum, visit a particular exhibit), or an item to use during the group action (e.g., for a business event, a particular type of clothing to wear) or an item to bring to the group action (e.g. for a birthday party, a gift to bring).

The recommendation engine may select the type of item to be recommended (e.g. whether to recommend clothing or a dish) based on what type of event the group action is, where different types of group actions are associated with different types of items.

According to various embodiments, one or more of the steps of the processes illustrated in FIG. 6, FIG. 7, and FIG. 8 may be removed or the ordering of the steps may be changed. Additionally, although separate embodiments are discussed herein, any combination of embodiments and/or partial embodiments discussed herein may be combined to form further embodiments.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

In particular, the disclosure also encompasses the subject matter of the following numbered clauses:

29. A group recommendation engine, executable on computer hardware, with electronic access to data relating to a plurality of group members, comprising: storage for recommendation rules, wherein a recommendation rule maps one or more preferences to one or more outcomes; storage for data representing actions that can be group recommendations to the plurality of group members; program code for processing the recommendation rules, data representing the actions, and preference data about two or more of the plurality of group members to determine a set of one or more group recommendations of an action for a group as a whole.

30. The group recommendation engine of clause 29, wherein the preference data comprises explicit preferences and implicit preferences.

31. The group recommendation engine of clause 29, wherein the action includes one or more of a purchase action, an attendance action, and/or an engagement action to be partaken in collectively by participating group members, wherein the action is optimized considering the group as a whole.

32. The group recommendation engine of clause 29 configured to be operated by a single member of the plurality of group members.

33. The group recommendation engine of clause 29 configured to be operated by two or more members of the plurality of group members.

34. The group recommendation engine of clause 29, further comprising program code for recommending membership for the plurality of group members.

35. The group recommendation engine of clause 29, wherein the program code for recommending membership for the plurality of group members further comprises program code for evaluating social graphs of group members.

36. The group recommendation engine of clause 29 configured to execute on one or more of a computer, laptop, tablet or mobile phone device.

37. The group recommendation engine of clause 29 configured to take into account one or more of weather data, location and/or explicit expressed preferences of one or more of the plurality of group members.

38. The group recommendation engine of clause 29 configured to take into account preferences of some group members who ultimately are not part of the group.

39. The group recommendation engine of clause 29 configured to take into account a group context for actions before making a group recommendation.

### 3. Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine customizable hard-wired logic, ASICs, or FPGAs with customizable programming to accomplish the techniques. The special-purpose computing devices may be desktop computer systems, portable computer systems, handheld devices, televisions, wearable computing devices, networking devices or any other device that incorporates hard-wired and/or program logic to implement the techniques.

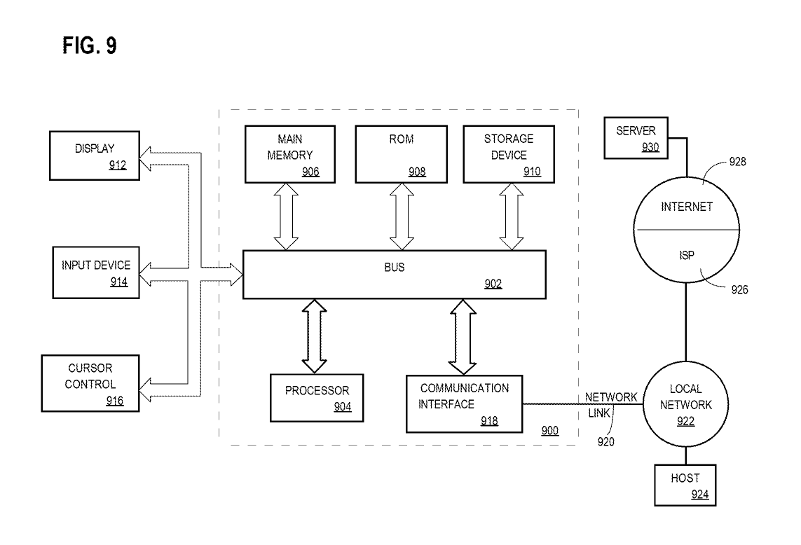

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

In some embodiments, a customer interacts with computer system 900 via touch, for example, by tapping or gesturing over certain locations. A display screen of display 912 may also be capable of detecting touch.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
determining information relating to each of a plurality of individuals;
based on the information relating to each of the plurality of individuals, determining a group action recommendation relating to a group comprising two or more individuals of the plurality of individuals and comprising an action for the group to participate in;
causing presentation of the group action recommendation at a computing device associated with a particular individual of the plurality of individuals;
wherein the method is performed using one or more computing devices.

2. The computer-implemented method of claim 1 further comprising:
determining, for each individual of a plurality of individuals, predicted satisfaction values indicating a prediction of how satisfied the individual will be with a plurality of group action recommendations;
selecting a particular group action recommendation from the plurality of group action recommendations wherein predicted satisfaction values associated with a first set of one or more individuals of the plurality of individuals are weighted more heavily than predicted satisfaction values associated with a second set of one or more individuals of the plurality of individuals during the selecting.

3. The computer-implemented method of claim 1 further comprising:
determining, for each group action of two or more group actions, a set of predicted satisfaction values, wherein the set of predicted satisfaction values includes a predicted satisfaction value for each individual of the plurality of individuals indicating how satisfied the individual will be with a recommendation for the group action;
selecting, for each group action of the two or more group actions, a minimum satisfaction value from the set of predicted satisfaction values associated with the group action, wherein the minimum satisfaction value indicates how satisfied a least satisfied individual of the plurality of individuals will be with a recommendation for the group action;
selecting a particular group action for recommendation over other group actions of the two or more group actions based on a determination that a minimum satisfaction value associated with the particular group action recommendation is greater than minimum satisfaction values associated with the other group action recommendations.

4. The computer-implemented method of claim 1 further comprising:
determining, for each individual of a first individual and a second individual, a predicted satisfaction value indicating a prediction of how satisfied each individual will be with a plurality of group action recommendations;
determining a context of a group action associated with the group action recommendation;
determining that the first individual is of a particular gender;
selecting a particular group action recommendation from the plurality of group action recommendations wherein, based on the context of the group action and that the first individual is of a particular gender, predicted satisfaction values associated with the first individual are weighted more heavily than predicted satisfaction values associated with the second individual during the selecting.

5. The computer-implemented method of claim 1 further comprising:
determining a recommended time for the group action based on information relating the two or more individual;
wherein the group action recommendation identifies the recommended time for the group action.

6. The computer-implemented method of claim 1 further comprising:
based on the information relating to each of the plurality of individuals, determining a plurality of group action recommendations including the group action recommendation;
causing presentation of the plurality of group action recommendations at a plurality of devices including the device associated with the particular individual;
receiving, from one or more device of the plurality of devices, votes for one or more group action recommendations of the plurality of group action recommendations;
based on the votes for the one or more group action recommendations, selecting at least one particular group action recommendation from the plurality of group action recommendations, wherein the at least one particular group action recommendation does not include all group action recommendations of the plurality of group action recommendations;
in response to selecting the at least one particular group action recommendation, sending a message to the device identifying the at least one particular group action recommendation.

7. The computer-implemented method of claim 1 further comprising:
based on the information relating to each of the plurality of individuals, determining a plurality of group action recommendations including the group action recommendation;
causing presentation of the plurality of group action recommendations at a plurality of devices including the device associated with the particular individual;
receiving, from one or more devices of the plurality of devices, down votes for one or more group action recommendations of the plurality of group action recommendations;
based on the down votes for the one or more group action recommendations, causing presentation of a particular group action recommendation at the device in place of the one or more group action recommendations, wherein the particular group action recommendation is different from the plurality of group action recommendations.

8. The computer-implemented method of claim 1 further comprising:
based on information relating to the plurality of individuals, selecting a confidence level, wherein each confidence level of a plurality of confidence levels is associated with different text for recommending the action;
wherein the group action recommendation comprises text associated with only the selected confidence level.

9. The computer-implemented method of claim 1 further comprising:
determining that one or more certain devices are in close proximity to a particular device;
based on the determination that the one or more certain devices are in close proximity to the particular device, determining that the group comprises individuals associated with the one or more certain devices and an individual associated with the particular device;
selecting the group action recommendation based on information relating to individuals associated with the one or more certain devices and the individual associated with the particular device.

10. The computer-implemented method of claim 1 further comprising:
receiving notification of a request to view a next channel on a television;
selecting a channel based on information relating to each of the two or more individuals;
in response to receiving the notification, causing the channel to be displayed on the television.

11. The computer-implemented method of claim 1 further comprising:
receiving, from a particular device, a request identifying a group action associated with the group action recommendation and requesting recommendations for participants of the group action;
selecting participants for the group action based on information associated with each individual of the plurality of individuals;
wherein the group action recommendation identifies the participants, wherein the participants are the two or more individuals.

12. The computer-implemented method of claim 1 further comprising:
receiving, from a particular device, a request identifying the two or more individuals and requesting a recommendation for a group action;
selecting the group action recommendation based on information associated with the two or more individuals;
wherein the group action recommendation identifies the group action.

13. The computer-implemented method of claim 1 wherein the group action recommendation is a bundled group action recommendation identifying a plurality of group actions to be performed in a sequence by the plurality of individuals.

14. A computer-implemented method comprising:
determining that a group action is planned for a group that includes at least a plurality of individuals including a particular user;
determining a recommendation for an item relating to the group action based on information relating to each of the plurality of individuals;
causing presentation of the recommendation for the item at a device associated with the particular user.

15. The computer-implemented method of claim 14 wherein the item is one or more of an activity to perform in preparation of the group action, an activity to perform during the group action, an item to experience during the group action, an item to use during the group action, or an item to bring to the group action.

16. The computer-implemented method of claim 14 further comprising:
determining, based on information obtained from a third-party application, that the group action is planned for the group that includes at least the plurality of individuals including the particular user.

17. A computer system comprising:
one or more processors;
one or more non-transitory computer-readable storage media storing instructions which when executed cause:
determining information relating to each of a plurality of individuals;
based on the information relating to each of the plurality of individuals, determining a group action recommendation relating to a group comprising two or more individuals of the plurality of individuals and comprising an action for the group to participate in;
causing presentation of the group action recommendation at a device associated with a particular individual of the plurality of individuals.

18. The computer system of claim 17, further comprising instructions which when executed cause:
determining, for each individual of a plurality of individuals, predicted satisfaction values indicating a prediction of how satisfied the individual will be with a plurality of group action recommendations;
selecting a particular group action recommendation from the plurality of group action recommendations wherein predicted satisfaction values associated with a first set of one or more individuals of the plurality of individuals are weighted more heavily than predicted satisfaction values associated with a second set of one or more individuals of the plurality of individuals during the selecting.

19. The computer system of claim 17, further comprising instructions which when executed cause:
determining, for each group action of two or more group actions, a set of predicted satisfaction values, wherein the set of predicted satisfaction values includes a predicted satisfaction value for each individual of the plurality of individuals indicating how satisfied the individual will be with a recommendation for the group action;
selecting, for each group action of the two or more group actions, a minimum satisfaction value from the set of predicted satisfaction values associated with the group action, wherein the minimum satisfaction value indicates how satisfied a least satisfied individual of the plurality of individuals will be with a recommendation for the group action;
selecting a particular group action for recommendation over other group actions of the two or more group actions based on a determination that a minimum satisfaction value associated with the particular group action recommendation is greater than minimum satisfaction values associated with the other group action recommendations.

20. The computer system of claim 17, further comprising instructions which when executed cause:
determining, for each individual of a first individual and a second individual, predicted satisfaction values indicating a prediction of how satisfied each individual will be with a plurality of group action recommendations;
determining a context of a group action associated with the group action recommendation;
determining that the first individual is of a particular gender;
selecting a particular group action recommendation from the plurality of group action recommendations wherein, based on the context of the group action and that the first individual is of a particular gender, predicted satisfaction values associated with the first individual are weighted more heavily than predicted satisfaction values associated with the second individual during the selecting.

21. The computer system of claim 17, further comprising instructions which when executed cause:
determining a recommended time for the group action based on information relating the two or more individual;
wherein the group action recommendation identifies the recommended time for the group action.

22. The computer system of claim 17, further comprising instructions which when executed cause:
based on the information relating to each of the plurality of individuals, determining a plurality of group action recommendations including the group action recommendation;
causing presentation of the plurality of group action recommendations at a plurality of devices including the device associated with the particular individual;
receiving, from one or more device of the plurality of devices, votes for one or more group action recommendations of the plurality of group action recommendations;
based on the votes for the one or more group action recommendations, selecting at least one particular group action recommendation from the plurality of group action recommendations, wherein the at least one particular group action recommendation does not include all group action recommendations of the plurality of group action recommendations;
in response to selecting the at least one particular group action recommendation, sending a message to the device identifying the at least one particular group action recommendation.

23. The computer system of claim 17, further comprising instructions which when executed cause:
based on the information relating to each of the plurality of individuals, determining a plurality of group action recommendations including the group action recommendation;
causing presentation of the plurality of group action recommendations at a plurality of devices including the device associated with the particular individual;
receiving, from one or more devices of the plurality of devices, down votes for one or more group action recommendations of the plurality of group action recommendations;
based on the down votes for the one or more group action recommendations, causing presentation of a particular group action recommendation at the device in place of the one or more group action recommendations, wherein the particular group action recommendation is different from the plurality of group action recommendations.

24. The computer system of claim 17, further comprising instructions which when executed cause:
based on information relating to the plurality of individuals, selecting a confidence level, wherein each confidence level of a plurality of confidence levels is associated with different text for recommending the action;
wherein the group action recommendation comprises text associated with only the selected confidence level.

25. The computer system of claim 17, further comprising instructions which when executed cause:
determining that one or more certain devices are in close proximity to a particular device;
based on the determination that the one or more certain devices are in close proximity to the particular device, determining that the group comprises individuals associated with the one or more certain devices and an individual associated with the particular device;
selecting the group action recommendation based on information relating to individuals associated with the one or more certain devices and the individual associated with the particular device.

26. The computer system of claim 17, further comprising instructions which when executed cause:
receiving notification of a request to view a next channel on a television;
selecting a channel based on information relating to each of the two or more individuals;
in response to receiving the notification, causing the channel to be displayed on the television.

27. The computer system of claim 17, further comprising instructions which when executed cause:
receiving, from a particular device, a request identifying a group action associated with the group action recommendation and requesting recommendations for participants of the group action;
selecting participants for the group action based on information associated with each individual of the plurality of individuals;
wherein the group action recommendation identifies the participants, wherein the participants are the two or more individuals.

28. The computer system of claim 17, further comprising instructions which when executed cause:
receiving, from a particular device, a request identifying the two or more individuals and requesting a recommendation for a group action;
selecting the group action recommendation based on information associated with the two or more individuals;
wherein the group action recommendation identifies the group action.

29. The computer-implemented method of claim 17 wherein the group action recommendation is a bundled group action recommendation identifying a plurality of group actions to be performed in a sequence by the plurality of individuals.

30. A computer system comprising:
one or more processors;
one or more non-transitory computer-readable storage media storing instructions which when executed cause:
determining that a group action is planned for a group that includes at least a plurality of individuals including a particular user;
determining a recommendation for an item relating to the group action based on information relating to each of the plurality of individuals;
causing presentation of the recommendation for the item at a device associated with the particular user.

31. The computer system of claim 30, wherein the item is one or more of an activity to perform in preparation of the group action, an activity to perform during the group action, an item to experience during the group action, an item to use during the group action, or an item to bring to the group action.

32. The computer system of claim 30, further comprising instructions which when executed cause:
determining, based on information obtained from a third-party application, that the group action is planned for the group that includes at least the plurality of individuals including the particular user.
